(19) United States
(12) Patent Application Publication
(10) Pub. No.: US 2010/0077264 A1
(43) Pub. Date: Mar. 25, 2010

(54) SERIALIZATION ALGORITHM FOR FUNCTIONAL ESD ROBUSTNESS

(76) Inventors: Oscar W. Freitas, (US); Nathan J. Charland, (US)

Correspondence Address: CESARI AND MCKENNA, LLP, 88 BLACK FALCON AVENUE, BOSTON, MA, 02210, US

(21) Appl. No.: 12/234,928

(22) Filed: Sep. 22, 2008

(51) Int. Cl. G06F 11/00

(52) U.S. Cl. 714/701; 714/E11.144

(57) ABSTRACT

An apparatus and method are described for sending serialized command in an environment where ESD or other phenomenon might cause malfunctions. Commands are encoded where there are at least two bit changes between any two commands. In this example, each command code that is different from legal commands by only one bit is an illegal command, Illustratively, if six bits provide 64 codes for commands, and only eight codes are used for legal commands, there will be 56 illegal command codes. Illustratively, any command code, that is only one bit different from a legal command, will be an illegal command. In practice a illegal command may be detected, and the system may recover. An illegal command due to and ESD event may be defined, and when detected a recovery process may be entered. When data (not command) are being sent, error detecting and correcting bits may be employed.

### BACKGROUND OF THE INVENTION

1. Field of the Invention

The present invention relates to improving operation of electronic devices when subjected to ESD (electrostatic discharge) events.

2. Background Information

Electronic device, for example mobile phones, may have false commands, displays or other malfunctions when ESD events occur. Most mobile phones are tested for ESD events, where narrow pulses up to 8 kV should not interfere with the mobile phones operation. The mobile phone display, however, may be garbled or reset, and erroneous commands may be activated by ESD events. Many mobile phones have an interface between two assemblies where a flexible circuit acts as a hinge. Since sending parallel data over the hinge, due to the large number of wires needed, maybe impractical, serializers and deserializers are employed to send serialized data over the hinge cable. Often a pair of wires carrying differential serial data and another pair carrying a differential clock signal are used.

Commands are sent serially over a flexible cable between two assemblies of a mobile phone with a boundary that distinguishes the types of commands from one another and from data being sent serially over the same wires. An ESD event, however, may physically change one command into another, confuse a command with data, change or garble data by affecting one bit of the serial flow of signals. An ESD event may also affect the serial clock being sent with the serial data and commands. Since the serial clock is used to synchronize and load the data bits at the receiver, anything that affects the integrity of the clock signals may cause a malfunction.

Capacitors may be placed on susceptible data lines to reduce the effects of an ESD, and ESD suppressors may be employed, but these approaches may be expensive and/or impractical.

It remains important to protect the serial transmissions from malfunctions due to ESD events.

### SUMMARY OF THE INVENTION

The present invention improves an electronic device that employs a serializer resistance to malfunctions due to ESD events.

The present invention provides for encoding control commands sent serially. In one embodiment, the commands are encoded with at least two bits being different between any two commands. The effect is to require at least two bits to be adulterated before a malfunction occurs. Advantageously, if an encoded command is received that does not correlate to any encoded command, that receipt may be understood as an error.

Illustratively, since information is often grouped with eight bits (a byte), there may be as many as eight bits or 256 combinations available to encode commands. Using those 256 combinations, where there may be only a total of 10-12 commands, finding codes where there are at least two bit differences among any two commands may be accomplished by inspection. Even three or more bit differences may be used in some applications. Illustratively fewer than eight bits may be used for commands in some applications.

Illustratively, when command are being sent to specific devices, e.g. LCD displays, a specific enable or chip select will be activated. When another device, e.g. a GPIO device, is being addressed, the sent data bits may encode that device, and further, when other operations, e.g. reset, is desired, that operation may be encoded in the sent data bits.

If an error or illegal command is received, especially a single bit error in a series of sent commands, the system may simply disregard it. Illustratively, an ESD event may cause errors in many sent commands, in this case the system may just remain inactive and disregard all received bytes for a given amount of time.

It will be appreciated by those skilled in the art that although the following Detailed Description will proceed with reference being made to illustrative embodiments, the drawings, and methods of use, the present invention is not intended to be limited to these embodiments and methods of use. Rather, the present invention is of broad scope and is intended to be defined as only set forth in the accompanying claims.

### BRIEF DESCRIPTION OF THE DRAWINGS

The invention description below refers to the accompanying drawings, of which:

FIG. 1 is block diagram of a system embodying the present invention; and

FIG. 2 is a table of commands, codes and operations.

### DETAILED DESCRIPTION OF AN ILLUSTRATIVE EMBODIMENT

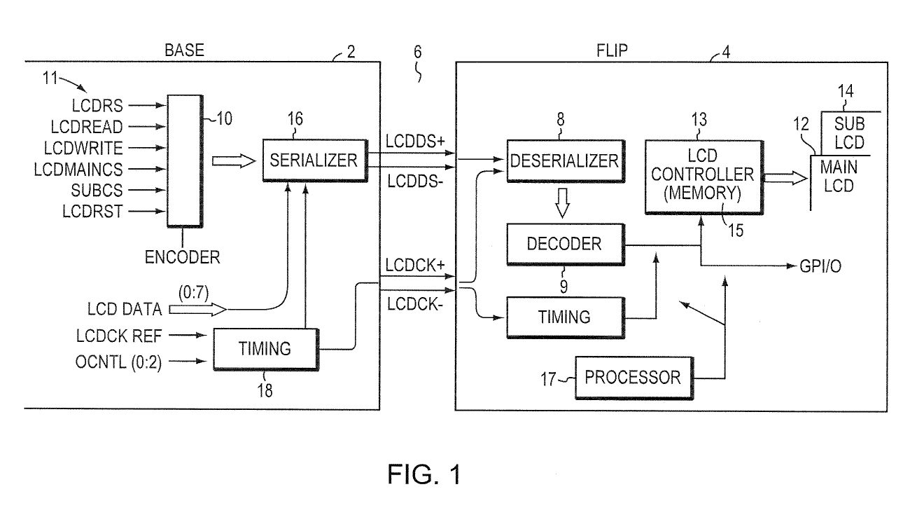

FIG. 1 is a block diagram of one embodiment of the present invention. A base 2, the main assembly of a mobile phone, is attached to the flip (or slide) assembly 4 of the mobile phone. The two assemblies are connected by a flexible cable 6 that carries at least two differential pairs of signal wires. One pair carries the LCD data (data here may include control information or display data) and the other pair carries clock signals used to load the data signals into a deserializer 8 in the flip assembly.

A processor (not shown) outputs to an encoder 10 representative control signals 11 for interfacing and displaying data on the MAIN LCD display 12 and/or the SUB LCD 14 display. Some mobile phones may not have the SUB LCD display. Illustratively, representative control signals 11 may include: LCDRS—register select; LCDMAINCS—main LCD display chip select; LCDSUBCS—sub LCD display chip select; LCDWRITE—write enable that loads the data or command into the selected register or chip; LCDREAD—read enable that allows the LCD controller (if available) to read the memory holding the data being displayed; and LCDRST—a reset signal for both LCD displays.

In more detail for the above illustrative LCD example, a processor (not shown) will generate a group of control bits in base assembly. LCDRS selects data or a command is being transferred to the Flip assembly. LCDMAINCS and LCDSUBCS determine which LCD display is being addressed; LCDREAD/LCDWRITE determines the operation being performed; and LCDRST resets the display controller and displays.

The LCD DATA illustratively comprises 8 bits (a byte) and the LCDCKREF, is a reference clock that provides all the time needed for the base 2, including the differential clock signals, LCDCK+/LCDCK−, on the flex cable 6.

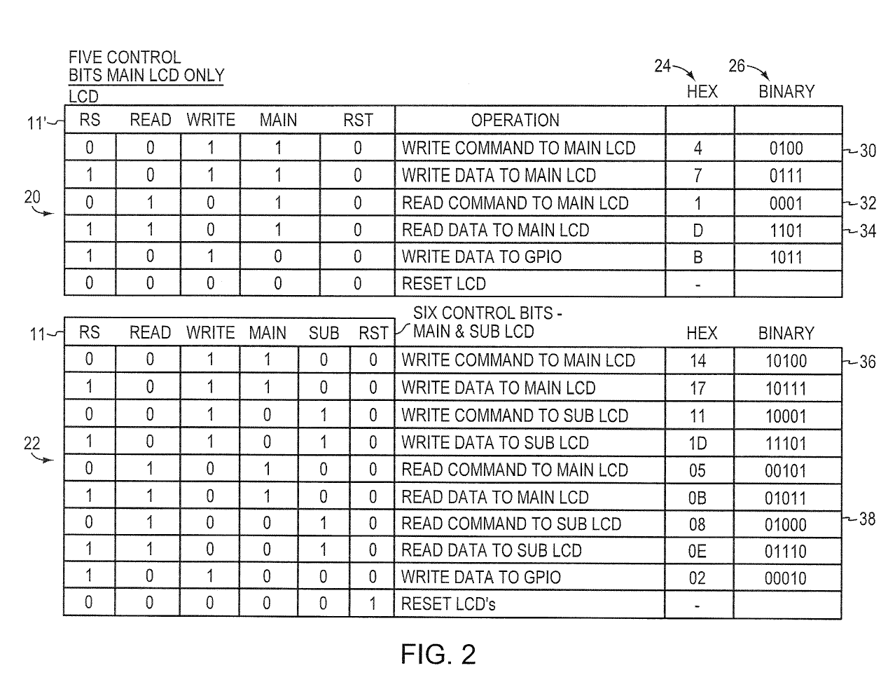

The six control bits in the base 6 are encoded as described below and loaded into a serializer 16 that, together with a timing signal from the timing circuit 18, outputs the serialized bits. These six control bits may be encoded 10, using six binary bit positions into sixty four combinations. In one embodiment, the combinations of the six control bits are encoded as in the table of FIG. 2. The top section 20 applies to a device with one LCD display, and section 22 to a device with both main and subordinate LCD displays.

The table is shows five 11′ of the six control bits 11 that are used if there is only the single LCD. The LCDSUBCS is not needed. The section 22 uses all six control bits 11.

The hex 24 and the binary notation indicate the actual bits that are serially transferred from the base to the flip assemblies to interface with the LCD displays 12 and 14.

With respect to the binary column 26 in section 20, note that between any two operations the binary code that is sent from the base 2 to the flip 4 always differ by at least two bits. That is two bits will change every time if a different operation is sent. To the LCD display. For example, from the binary item 30 contents 0100 to item 32, contents 0001 the first and the third (from right to left) bits change. From item 32 to 34, the third and the fourth bits change. Between any two operations at least two bits change. In section 22, the binary column follows the same pattern. For example, item 36, 1 0100, to item 38, 0 1000, the third, fourth and fifth bits change. Again, at least two bits change between any two operations.

If the decoder 9 in the flip assembly 4 receives a binary code for an operation that does not appear in the tables of FIG. 2, an error has been detected, and the FLIP assembly may be designed with a processor 17 that controls the responses.

Since an ESD event typically may cause a catastrophic series of erroneous operations to be received by the Flip assembly. For example, if the processor 17 detects a series of illegal commands, the processor may shut down some time period, the processor 17 may initiate a reset of the LCD circuitry; and the processor may hold the last GPIO output is some known state.

If the error does not fit the criteria for an error from an ESD event, for example if a single bit error is detected in a series of legal commands, The processor may simply disregard the erroneous command. If the error occurred in a stream of data bytes, the bit error may be corrected if additional error detecting and correcting bits (not shown) are employed.

In another case, the FLIP a processor 17 may be designed to return an error signal (not shown) to the BASE 2 where the last operation is repeated. Alternatively, a reset may be commanded by the processor as if an (RST=1) were received.

Typically an ESD event may adulterate several operations, and the FLIP processor 17 may be designed respond to a known ESD event to compile a list of the last several operations sent to the FLIP assembly 4. The processor may examine the last operations and if, for example, two of the last 5 were erroneous, the cause may be determined to be an ESD event. In such a case the flip assembly may shut down for some time period.

Referring back to FIG. 1, the flip assembly 4 shows an LCD controller 13 having a memory 15. In operation the data to be displayed is held in the controller memory 15. When the operation, FIG.2, is a READ command to one of the LCD display, that operation will cause the controller to read the memory and output the contents to the LCD display. In the event of an error, this would restore the LCD display.

In applications where individual read/write enables or chip selects are not encoded, as in the table or FIG.2, other commands may be transferred in the data fields. In these cases, several repetitions of the data field commands may be sent to ensure proper operations.

It should be understood that above-described embodiments are being presented herein as examples and that many variations and alternatives thereof are possible. Accordingly, the present invention should be viewed broadly as being defined only as set forth in the hereinafter appended claims.

What is claimed is:

1. A method for protecting valid information being transferred, the method comprising the steps of:
selecting a first number of bits;
encoding the valid information using the first number of bits;
wherein the code for a valid piece of information is always at least two bits different from the code for any other valid piece of information.

2. The method of claim 1 further comprising the step of serializing and sending the encoded valid information bit by bit.

3. The method of claim 1, wherein the valid information comprises command information.

4. The method of claim 3 further comprising the steps of:
detecting invalid command information and responding by stopping any write or read commands from being implemented.

5. The method of claim 3 further comprising the step of activating a number of reset commands.

6. The method of claim 3 wherein the recipient of the serialized information is an LCD display and further comprising the steps of determining that an ESD event caused the invalid information.

7. The method of claim 1 further comprising the step of sending bit correction information, detecting invalid information and correcting the bit errors.

8. Apparatus for protecting valid information being transferred, the apparatus comprising:
an encoder that receives and encodes the valid information;
a first number of bits used by the encoder for encoding the information; wherein the first number allows the set of possible codes to be large enough wherein the code for a valid piece of information is always at least two bits different from any other code for a valid piece of information.

9. The apparatus of claim 8 further comprising a serializer that receives and sends the encoded valid information bit by bit.

10. The apparatus of claim 8, wherein the valid information comprises command information.

11. The apparatus of claim 10 further comprising:
a detector for detecting invalid command information and responds by stopping any write or read commands from being implemented.

12. The apparatus of claim 11 wherein when one or more invalid commands are detected the detector responds by activating a number of reset commends.

13. The apparatus of claim 11 further comprising
an LCD display that receives the serialized information.

14. The apparatus of claim 8 further comprising extra bits attached to data and command information, wherein the extra bits are used to detect and correct bit errors.
